(19) United States
(12) Patent Application Publication
(10) Pub. No.: US 2022/0004742 A1
(43) Pub. Date: Jan. 6, 2022

(54) METHOD FOR FACE RECOGNITION, ELECTRONIC EQUIPMENT, AND STORAGE MEDIUM

(71) Applicant: SHENZHEN SENSETIME TECHNOLOGY CO., LTD., Shenzhen (CN)

(72) Inventors: Siting HU, Shenzhen (CN); Wenzhong JIANG, Shenzhen (CN); Hongbin ZHAO, Shenzhen (CN); Chen CHEN, Shenzhen (CN); Junqiang LI, Shenzhen (CN)

(21) Appl. No.: 17/481,431

(22) Filed: Sep. 22, 2021

Related U.S. Application Data
(63) Continuation of application No. PCT/CN2020/088136, filed on Apr. 30, 2020.

(30) Foreign Application Priority Data
Jul. 30, 2019 (CN) 201910695535.8

(51) Int. Cl. G06K 9/00; G06K 9/46; G06K 9/20

(52) U.S. Cl. CPC G06K 9/00288; G06K 9/00268; G06K 9/00771; G06K 9/2027; G06K 9/00906; G06K 9/4661

(57) ABSTRACT

An ambient light parameter is acquired by detecting ambient light of a surveillance area. When there is a target object in the surveillance area, a movement distance of the target object is detected. When the ambient light parameter meets an ambient light condition and the movement distance of the target object is no less than a distance threshold, the ambient light parameter is changed by adjusting screen brightness of a display device according to the ambient light parameter. A face image of the target object after the ambient light parameter has been changed is acquired. A comparison result of comparing the face image to a preset image is acquired. A face recognition result is acquired according to the comparison result.

### CROSS-REFERENCE TO RELATED APPLICATIONS

This application is a continuation of International Application No. PCT/CN2020/088136, filed on Apr. 30, 2020, which per se claims benefit of priority to Chinese Application No. 201910695535.8, filed on Jul. 30, 2019. The contents of International Application No. PCT/CN2020/088136 and Chinese Application No. 201910695535.8 are incorporated herein by reference in their entireties.

### TECHNICAL FIELD

The disclosure relates to the field of security, and more particularly, to a method for face recognition, electronic equipment, and a storage medium.

### BACKGROUND

Face recognition and verification in dark light poses a great challenge in the field, and demands much on equipment performance and a recognition algorithm. In general, face recognition is performed using an infrared image. Alternatively, fill light may be required to acquire a face image of a target object. Consequently, additional auxiliary equipment such as an infrared camera or a fill light increases cost of using the art. Moreover, an infrared image recognition algorithm is complicated.

### SUMMARY

Embodiments herein provide a method for face recognition, electronic equipment, and a storage medium.

According to an aspect herein, a method for face recognition is applied to a one-piece machine for face recognition. The one-piece machine for face recognition is provided with a display device. The method includes:

acquiring an ambient light parameter by detecting ambient light of a surveillance area;

in response to existence of a target object in the surveillance area, detecting a movement distance of the target object;

in response to the ambient light parameter meeting an ambient light condition and the movement distance of the target object being no less than a distance threshold, changing the ambient light parameter by adjusting screen brightness of the display device according to the ambient light parameter; and

acquiring a face image of the target object after the ambient light parameter has been changed, acquiring a comparison result of comparing the face image to a preset image, and acquiring a face recognition result according to the comparison result.

According to an aspect herein, a device for face recognition includes a first detecting module, a second detecting module, an adjusting module, and a comparing module.

The first detecting module is configured for acquiring an ambient light parameter by detecting ambient light of a surveillance area.

The second detecting module is configured for, in response to existence of a target object in the surveillance area, detecting a movement distance of the target object.

The adjusting module is configured for, in response to the ambient light parameter meeting an ambient light condition and the movement distance of the target object being no less than a distance threshold, changing the ambient light parameter by adjusting screen brightness of the display device according to the ambient light parameter.

The comparing module is configured for acquiring a face image of the target object after the ambient light parameter has been changed, acquiring a comparison result of comparing the face image to a preset image, and acquiring a face recognition result according to the comparison result.

According to an aspect herein, electronic equipment includes a processor and memory. The memory is configured for storing instructions executable by the processor. The processor is configured for implementing a method for face recognition herein when executing the instructions.

According to an aspect herein, a computer-readable storage medium has stored thereon computer program instructions which, when executed by a processor, implement a method for face recognition herein.

### BRIEF DESCRIPTION OF THE ACCOMPANYING DRAWINGS

Drawings here are incorporated in and constitute part of the disclosure, illustrate embodiments according to the disclosure, and together with the disclosure, serve to explain the principle of the disclosure.

FIG. 1 is a flowchart 1 of a method for face recognition according to an embodiment herein.

FIG. 2 is a flowchart 2 of a method for face recognition according to an embodiment herein.

FIG. 3 is a flowchart 3 of a method for face recognition according to an embodiment herein.

FIG. 4 is a flowchart 4 of a method for face recognition according to an embodiment herein.

FIG. 5 is a diagram of applying a method for face recognition according to an embodiment herein.

FIG. 6 is a block diagram of a device for face recognition according to an embodiment herein.

FIG. 7 is a block diagram of electronic equipment according to an embodiment herein.

FIG. 8 is a block diagram of electronic equipment according to an embodiment herein.

### DETAILED DESCRIPTION

Exemplary embodiments, characteristics, and aspects herein are elaborated below with reference to the drawings. Same reference signs in the drawings may represent elements with the same or similar functions. Although various aspects herein are illustrated in the drawings, the drawings are not necessarily to scale unless expressly pointed out otherwise.

The dedicated word “exemplary” may refer to “as an example or an embodiment, or for descriptive purpose”. Any embodiment illustrated herein as being “exemplary” should not be construed as being preferred to or better than another embodiment.

A term “and/or” herein merely describes an association between associated objects, indicating three possible relationships. For example, by A and/or B, it may mean that there may be three cases, namely, existence of but A, existence of both A and B, or existence of but B. In addition, a term “at least one” herein means any one of multiple, or any combination of at least two of the multiple. For example, including at least one of A, B, and C may mean including any one or more elements selected from a set composed of A, B, and C.

Moreover, a great number of details are provided in embodiments below for a better understanding of the disclosure. A person having ordinary skill in the art may understand that the disclosure can be implemented without some details. In some embodiments, a method, means, an element, a circuit, etc. , that is well-known to a person having ordinary skill in the art may not be elaborated in order to highlight the main point of the disclosure.

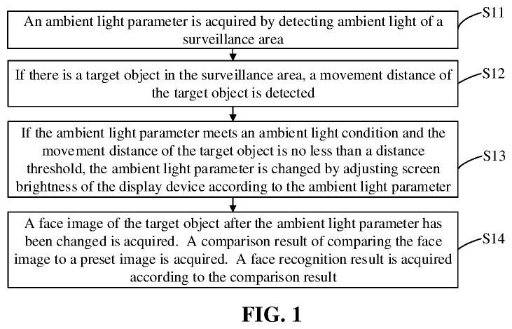

FIG. 1 is a flowchart 1 of a method for face recognition according to an embodiment herein. As shown in FIG. 1, the method is applied to a one-piece machine for face recognition. The one-piece machine for face recognition is provided with a display device. The method includes operations as follows.

In operation S11, an ambient light parameter is acquired by detecting ambient light of a surveillance area.

In operation S12, when there is a target object in the surveillance area, a movement distance of the target object is detected.

In operation S13, when the ambient light parameter meets an ambient light condition and the movement distance of the target object is no less than a distance threshold, the ambient light parameter is changed by adjusting screen brightness of the display device according to the ambient light parameter.

In operation S14, a face image of the target object after the ambient light parameter has been changed is acquired. A comparison result of comparing the face image to a preset image is acquired. A face recognition result is acquired according to the comparison result.

With a method for face recognition herein, in case an ambient light parameter meets an ambient light condition and there is a target object in the surveillance area with a movement distance no less than a distance threshold, fill light may be provided to a target object through a display device. Comparison may be performed on a face image collected under fill light. Accordingly, a face recognition result may be acquired in dark ambient light without additional auxiliary equipment such as an infrared camera or a fill light, reducing a hardware cost.

In some embodiments, the method for face recognition may be executed by terminal equipment or other processing equipment. Terminal equipment may be User Equipment (UE), a one-piece machine for face recognition, mobile equipment, a user terminal, a terminal, a cell phone, a cordless phone, a Personal Digital Assistant (PDA), handheld equipment, computing equipment, on-board equipment, wearable equipment, etc. Other processing equipment may be a server or a cloud server, etc. In some possible implementations, the method for face recognition may be implemented by a processor by calling computer-readable instructions stored in memory.

In some embodiments, the method for face recognition may be applied to a one-piece machine for face recognition, such as access control equipment or attendance equipment, for performing face recognition on a visitor, and/or recording information such as identification, visiting time, etc., of the visitor. The method for face recognition may also be applied to another field such as recognition, unlocking, etc., of equipment or an application. An application field of the method for face recognition is not limited hereto.

In some embodiments, In operation S11, an ambient light parameter is acquired by detecting ambient light of a surveillance area.

In an example, a surveillance area may include an area recognizable by a one-piece machine for face recognition. A one-piece machine for face recognition may be provided in the surveillance area. An ambient light parameter of ambient light in the surveillance area may be detected through a light sensing device such as a light sensor of the one-piece machine for face recognition. The ambient light parameter may include at least a parameter such as brightness of the ambient light, such as a light intensity of the ambient light. It may be determined whether fill light is required in face image photography according to brightness or intensity of the ambient light. For example, a face image photographed in a scene with low-brightness ambient light may be of poor quality. For example, the face image may be blurred. Brightness of the image may be low. No face feature may be acquired from the face image, etc. Accordingly, fill light is required for face image photography in a scene with such ambient light. With bright ambient light, a photographed face image may be of good quality, and no fill light is required for face image photography.

In some embodiments, in operation S12, when there is a target object in the surveillance area, a movement distance of the target object is detected.

In an example, it may be determined whether there is any target object in a surveillance area via infrared sensing, target detection, etc. A movement distance of a target object may be detected through a distance measuring device (such as an infrared distance measuring device) of a one-piece machine for face recognition. It may be determined whether a face image is to be collected by detecting the movement distance of the target object. For example, if there is an approaching target object in the surveillance area, the target object may be approaching the one-piece machine for face recognition and intend to pass through a door. Accordingly, a face image may have to be collected for recognition. If there is no moving target object in the surveillance area (such as when there is no target object in the surveillance area, or but an immobile target object in the surveillance area), no face image is to be collected. By the movement distance of the target object being no less than a distance threshold, it may mean that the target object is detected to have moved a distance greater than or equal to the distance threshold, such that a distance between the target object and a distance measuring device is decreasing.

In some embodiments, in operation S13, the ambient light parameter may include brightness of the ambient light. The ambient light condition may include that the brightness of the ambient light is no greater than a brightness threshold. For example, the brightness threshold may be set to be 5 lux, which is not limited hereto. When the ambient light parameter meets an ambient light condition and the movement distance of the target object is no less than a distance threshold (such as when the distance threshold is set to be 10 cm, which is not limited hereto), namely when a target object is approaching in the surveillance area (which means a face image may have to be collected for recognition) and the brightness of the ambient light is low (namely fill light is required), brightness of the display device may be adjusted according to the ambient light parameter to provide fill light to the target object. For example, the display device may be turned on, changing the ambient light parameter of the face area using light emitted by the display device.

In some embodiments, operation S13 may include an option as follows. A display interface in a predetermined mode may be displayed on a display screen of the display device. In the predetermined mode, the display screen of the display device may be turned on, and a light (such as white) background may be displayed on the display screen, such that the display screen of the display device emits bright light. Furthermore, in the predetermined mode, the display device may be made to perform display according to a predetermined display parameter.

In some embodiments, operation S13 may include an option as follows. A display parameter of the display device may be determined according to the ambient light parameter. The screen brightness of the display device may be adjusted according to the display parameter. Optionally, the display parameter may include an area ratio of an adjustable area in the display device, and at least one of a gray scale, a brightness, and a chroma of the adjustable area. The adjustable area may be a to-be-adjusted area on the display screen of the display device when providing fill light to the target object through the display device. For example, the brightness of the area may be adjusted to increase the brightness of the area, which then emits bright light to provide fill light to the target object. In an example, the less the brightness of the ambient light is, the greater the area ratio of the adjustable area, or the greater at least one of the grayscale, the brightness, and the chroma of the adjustable area.

In some embodiments, a display parameter of the display device corresponding to the ambient light parameter may be preset. That is, a predetermined mode may be preset. In application, multiple tests may be done under various light conditions. For example, a display parameter may be tested when brightness of ambient light is 5 lux. For example, the area ratio of the adjustable area in the display device (i.e., a ratio of the adjustable area to a display area of the display device) and at least one of the grayscale, the brightness, and the chroma of the adjustable area may be adjusted, changing brightness of light emitted by the adjustable area of the display device. In addition, the face of the target object in front of the display device may be photographed, acquiring a face image for image quality detection. If the image is of poor quality, the area ratio of the adjustable area may be increased, or at least one of the grayscale, the brightness, and the chroma of the adjustable area may be increased, until quality of the image meets an identification standard (such as a parameter such as a clarity, brightness, etc., of the image meets a standard, and identification may be implemented through the image). Furthermore, brightness of the ambient light may be changed. For example, the brightness of the ambient light may be adjusted to be 4 lux. Furthermore, the area ratio of the adjustable area in the display device, and at least one of the grayscale, the brightness, and the chroma of the adjustable area, may be adjusted (for example, the area ratio of the adjustable area, or at least one of the grayscale, the brightness, and the chroma of the adjustable area, may be increased), until a face image provided with fill light meets the identification standard under ambient light of brightness of 4 lux. In this way, display parameters allowing the face image provided with fill light to meet the identification standard under ambient light of various brightness, may be determined. That is, a correspondence between an ambient light parameter and a display parameter may be established.

In some embodiments, based on the established correspondence, when an ambient light parameter is detected through a light sensing device such as a light sensor, a display parameter corresponding to the ambient light parameter may be determined. For example, if an ambient light parameter of 3 lux is detected, an area ratio of the adjustable area, and at least one of a grayscale, a brightness, and a chroma of the adjustable area, corresponding to 3 lux, may be determined. The display device may be adjusted according to the display parameter as determined, namely the display screen of the display device may be set according to a corresponding display parameter. For example, the adjustable area in the display screen of the display device may be made brighter, and at least one of the grayscale, the brightness, and the chroma of the adjustable area may be adjusted, such that that light emitted by the display device may serve as fill light to the target object, and a face image of the target object provided with fill light may meet the identification standard.

In this way, a display parameter of a display device may be determined according to the ambient light parameter, and the display device may be adjusted according to the display parameter, such that the display device emits light to provide fill light to the target object, without using additional auxiliary equipment such as an infrared camera or a fill light, reducing usage cost.

In some embodiments, in operation S14, light emitted by the display device may provide fill light to the target object. An image acquiring device (such as a camera) of the one-piece machine for face recognition may be turned on to photograph an image of the surveillance area when the display device emits light. A photographed image may be determined as a face image of the target object.

In some embodiments, operation S14 may include an option as follows. A first image of the target object may be acquired. Image quality detection may be performed on the first image. A first image meeting a quality condition may be determined as the face image of the target object.

In one embodiment, an image acquiring device may photograph a first image of a target object in a surveillance area. The first image may be a Red Green Blue (RGB) image. In application, multiple first images of the target object may be photographed. Quality detection may be performed on the multiple first images to determine whether a first image meets the quality condition.

In some examples, it may be verified whether a parameter such as a clarity, brightness, etc., of the first image meets the identification standard. In some other examples, it may be verified whether a first image includes a complete face. For example, a first image may include only a body of the target object and no face of the target object. Alternatively, part of the face of the target object may not be included in a first image. For example, part of the face of the target object may go beyond a boundary of a first image, such as an upper boundary, a left boundary, a right boundary, or a lower boundary of the first image. Consequently, the face of the target object in the first image may be incomplete. In some other examples, consider an angle of the face of the target object in the first image or whether the face of the target object is blocked from view. For example, a face key point may be detected in a first image. If the angle of the face is in a certain range, or a view blocking ratio is in a certain range, a number of face key points enough to allow the first image to meet the quality condition may be extracted. If the angle of the face is beyond the certain range or the view blocking ratio is beyond the certain range, not enough face key points may be extracted, such that no effective feature may be extracted from the first image in face comparison. Accordingly, no effective face comparison may be performed. Therefore, the first image may be deemed not meeting the quality condition. One or more images meeting the quality condition may be selected from multiple first images as face images of the target object. The quality condition may include whether a parameter such as clarity, brightness, etc., of an image reaches a preset threshold to allow a face feature of the target object to be extracted from the first image. The quality condition may include whether the face of the target object in a first image is complete, whether there is no view blockage, whether an angular offset is small, etc., to allow a face feature of the target object to be extracted from the first image. A quality condition is not limited hereto. Of course, it may be determined whether a first image meets the quality condition based on one or more modes proposed herein, which is not limited hereto.

In this way, a face image meeting a quality condition may be acquired from multiple first images, improving accuracy of identification performed on a face image.

In some embodiments, the one-piece machine for face recognition may determine whether a face image is acquired. If no face image of the target object is acquired within certain time, the target object in the surveillance area may have left, such as when the target object is only a passenger passing by a target area and does not intend to get through the door or perform identification. Therefore, identification processing may be stopped.

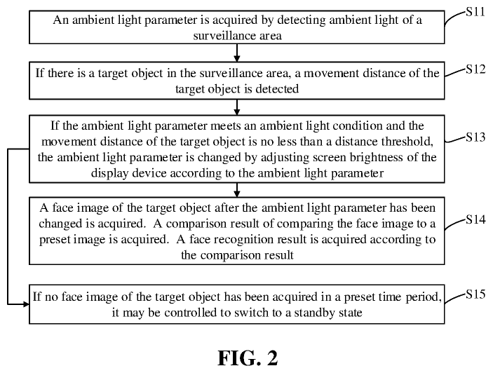

Based on the embodiment, FIG. 2 is a flowchart 2 of a method for face recognition according to an embodiment herein. As shown in FIG. 2, the method may further include a step as follows.

In operation S15, if no face image of the target object has been acquired in a preset time period, it may be controlled to switch to a standby state.

In some embodiments, the preset time period may be 10 seconds, half a minute, one minute, etc., which is not limited hereto. If no face image has been acquired within the preset time period, the target object may not intend to perform identification. The one-piece machine for face recognition may be controlled to switch to the standby state, or the display device may be controlled to switch to the standby state, to prevent the display device from being kept in a high-brightness state for a long time, protecting the display device, reducing loss of the display screen of the display device, increasing a service life of the display device, reducing power consumption.

In some embodiments, operation S14 may include an option as follows. A liveness detection result of performing liveness detection on the face image may be acquired. If the liveness detection result indicates liveness, a face feature of the target object may be acquired by performing feature extraction processing on the target object in the face image. The comparison result may be acquired by comparing the face feature of the target object to a face feature in the preset image.

In the embodiment, liveness detection may be performed on a face in a face image. For example, it may be verified that a face in a face image is a real face, instead of one collected from a photo, a mask, a screen shot, etc. In an example, liveness detection may be performed on a face image through a neural network, etc. Various frauds such as a high-definition photo, a processed image, a three-dimensional model, a three-dimensional dummy, a masked face, etc., may be distinguished. Liveness detection may be performed without the target object aware of it. If the liveness detection result indicates no liveness, further recognition may be stopped. For example, the one-piece machine for face recognition may stop recognition, refuse to open the door, and switch to the standby state, to stop processing such as providing fill light to the target object, photographing a face image of the target object, etc.

In the embodiment, if liveness detection result of a face image indicates liveness, feature extraction may be performed on a face of a target object in the face image. For example, a feature such as a face key point may be extracted. In an example, feature extraction may be performed on a face image through a convolutional neural network, acquiring a face feature of a target object.

Furthermore, a face feature of the target object may be compared to a face feature in the preset image. Exemplarily, multiple preset images may be stored in a database of the one-piece machine for face recognition. Objects in the multiple preset images may be objects with access control permission. Understandably, the one-piece machine for face recognition may open the door to allow a target object to pass when it detects that the target object match an object in a preset image. For example, the one-piece machine for face recognition may be a one-piece machine for face recognition of a certain corporation. The preset images may be face images of employees of the corporation pre-stored in a database of the one-piece machine for face recognition. Optionally, a face feature of a face in a preset image may also be stored in the database of the one-piece machine for face recognition. In an implementation, after a preset image has been stored in the one-piece machine for face recognition, a related feature extraction algorithm may be called to extract a face feature in the preset image, and the face feature corresponding to the preset image may be stored.

In the embodiment, a face feature of a target object in a face image may be compared to a face feature in a preset image, acquiring a comparison result, such as by determining a feature similarity between the face feature in the face image and the face feature in each preset image. If the feature similarity (such as a cosine similarity) between the face feature in the face image and the face feature in a preset image is greater than a similarity threshold, it may mean that the face feature of the target object matches the face feature in the preset image. That is, the target object in the face image matches the object in the preset image. For example, preset images of an object 1, an object 2, . . . , and an object n, and face features of the objects may be stored in the database. The face feature of the target object may match the face feature in the preset image of the object 2. Then, the target object may be identified as the object 2. It may also mean that the target object is authenticated. Correspondingly, if the feature similarity (such as the cosine similarity) between a face feature in a face image and a face feature in each preset image is no greater than the similarity threshold, it may mean that the face feature of the target object does not match face features in the preset images. That is, the target object in the face image matches no object in the preset images.

In the embodiment, the comparison result, or authentication result, may be determined as the face recognition result. That is, the comparison result may be whether the face feature of the target object matches the face feature in the preset image, or whether the target object in the face image matches the object in the preset image, or whether the target object in the face image is authenticated.

In some optional embodiments of the disclosure, after the target object has been authenticated, identification of the target object, and information indicating that the target object has been authenticated, may further be displayed on the display device. For example, in the example, the display device may display that the target object is the object 2, and the target object is allowed to enter. After face recognition on the target object has ended, the display device may be turned off, to reduce loss of the display device.

In this way, first, liveness detection may be performed on a face image, improving identification security and reliability. Identification may be performed through a face feature, improving identification accuracy.

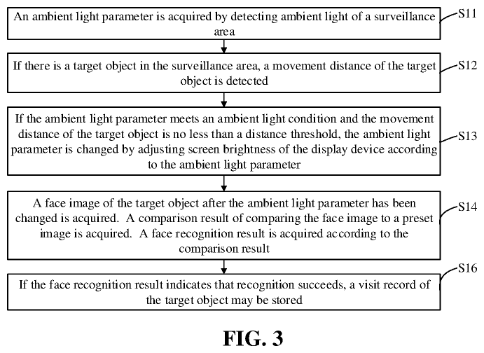

FIG. 3 is a flowchart 3 of a method for face recognition according to an embodiment herein. As shown in FIG. 3, the method may further include a step as follows.

In operation S16, if the face recognition result indicates that recognition succeeds, a visit record of the target object may be stored.

In the embodiment, if the feature similarity (such as the cosine similarity) between a face feature in a face image and a face feature in a preset image is greater than a similarity threshold, it may mean that the face feature of the target object matches the face feature in the preset image, and it may also be determined that the face recognition result is that recognition succeeds. If the feature similarity (such as the cosine similarity) between a face feature in a face image and a face feature in each preset image is no greater than the similarity threshold, it may mean that the face feature of the target object does not match face features in the preset images, and it may also be determined that the face recognition result is that recognition fails.

In the embodiment, a visit record of the target object may include information such as identification, visiting time, etc., of the target object. For example, when the one-piece machine for face recognition is a one-piece machine for face recognition of a corporation, and the target object is an employee of the corporation, if identification of the target object matches preset identification, identification of the target object (such as an identifier of the target object) and the visiting time of the target object may be recorded. In an application scene, the one-piece machine for face recognition may serve as attendance equipment for recording time when an employee arrives at the corporation. Alternatively, time when a person arrives at a place may be recorded, providing a basis for criminal investigation. An application field of the visit record is not limited hereto.

In this way, a visit record of a target object may be recorded, improving flexibility in using the identification.

In some possible implementations, when the face recognition result indicates that recognition fails, such as when the target object is not an employee of the corporation, or identification processing fails because of an issue such as a photographing angle, the target object may be recognized again, or the target object may be notified of the failure.

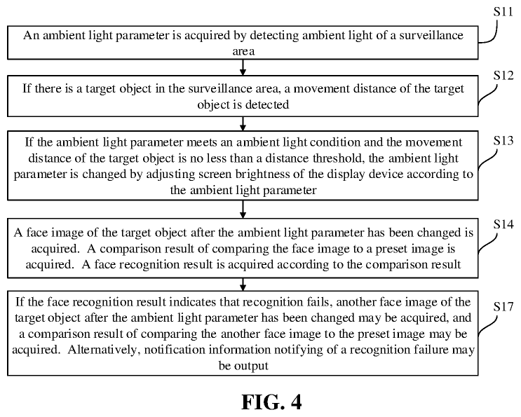

FIG. 4 is a flowchart 4 of a method for face recognition according to an embodiment herein. As shown in FIG. 4, the method may further include a step as follows.

In operation S17, if the face recognition result indicates that recognition fails, another face image of the target object after the ambient light parameter has been changed may be acquired. A comparison result of comparing the another face image to the preset image may be acquired. Alternatively, notification information notifying of a recognition failure may be output.

In the embodiment, identification of a target object may match no preset identification, possibly because of an issue in face image photography, such as a photographing angle, etc. Therefore, a face image of the target object provided with fill light (namely after the ambient light parameter has been changed) may be acquired. In addition, recognition and comparison may be performed again through a method for face recognition herein. If a new recognition and comparison result indicates that recognition succeeds, a visit record of the target object may be recorded, and the door may be opened to allow the target object to enter. If the new recognition and comparison result indicates that recognition fails, another face image of the target object may be acquired for recognition and comparison, which may be repeated for an indefinite number of times. If a new recognition and comparison result indicates that recognition fails, the target object is prohibited from passing through the door. The door may not be opened until the comparison result indicates that recognition succeeds. The number of comparisons may be limited to 5 times, for example. If comparison is performed 5 times for the target object, and identification of the target object matches no preset identification, comparison may be stopped, it may be controlled to switch to the standby state, and notification information notifying of a recognition failure may be output. For example, notification information notifying of a recognition failure may be displayed on the display device. Alternatively, notification information may be played through an audio playing device such as a loudspeaker. A number limit and a notification information output mode are not limited hereto.

In this way, mismatching caused by a photographing problem may be avoided, improving recognition accuracy and reliability.

With a method for face recognition herein, in a first aspect, in case an ambient light parameter meets an ambient light condition and there is a target object in the surveillance area with a movement distance no less than a distance threshold, fill light may be provided to a target object through a display device. A face image meeting a quality condition may be acquired from multiple first images. A face recognition result may be acquired in dark ambient light, improving accuracy of identification performed on a face image. In a second aspect, when a face image collected with fill light is recognized, first, liveness detection may be performed on the face image, improving identification security and reliability, without using additional auxiliary equipment such as an infrared camera or a fill light, reducing usage cost. In third aspect, a visit record of a target object may be recorded, improving flexibility in using a method for face recognition herein. In a fourth aspect, when identification of a target object matches no preset identification, face image collection, recognition, and comparison may be performed again on the target object, avoiding a recognition failure caused by a photographing problem, increasing recognition accuracy and reliability. In a fifth aspect, when recognition fails, a liveness detection result indicates no liveness, and identification processing completes, it may be controlled to switch to a standby state, reducing loss of a display screen, increasing a service life of the display device, reducing power consumption.

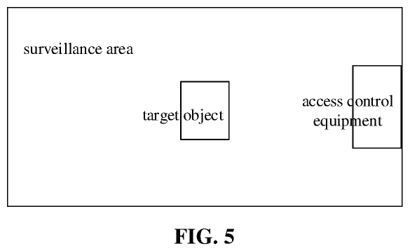

FIG. 5 is a diagram of applying a method for face recognition according to an embodiment herein. As shown in FIG. 5, the method for face recognition is applied to a one-piece machine for face recognition or attendance equipment, for recognizing a target object in a surveillance area.

In some embodiments, the one-piece machine for face recognition may include an image acquiring device, a display device, an infrared distance measuring device, a brightness sensor, etc. The brightness sensor may acquire an ambient light parameter such as brightness of ambient light. The infrared distance measuring device may detect whether there is an object that is moving in the surveillance area.

In some embodiments, if brightness of ambient light is no greater than a brightness threshold (such as 5 lux), and there is a target object in the surveillance area with a movement distance no less than a distance threshold (such as 10 cm), a display device may be adjusted according to an ambient light parameter. For example, screen brightness of the display device may be adjusted, increasing brightness of the ambient light, thereby providing fill light to the target object.

In some embodiments, one or more correspondences, each between an ambient light parameter and a display parameter of the display device, may be preset. A display parameter corresponding to a detected ambient light parameter may be determined. Accordingly, an area ratio of an adjustable area of the display device, and at least one of a grayscale, a brightness, and a chroma of the adjustable area, may be adjusted according to the display parameter, thereby adjusting light emitted by the display device, increasing brightness of the ambient light, providing fill light to the target object.

In some embodiments, an image acquiring device may acquire multiple first images of a target object. A first image with a complete face, a low view blocking ratio, and a small angular offset may be selected as the face image. Furthermore, liveness detection may be performed on the face image to verify whether the target object in the face image is from a living body, instead of one collected from a photo, a mask, a screen shot, etc. When a liveness detection result indicates liveness, feature extraction may be performed on the face image, and an extracted face feature may be compared to a face feature in a preset image in a database, determining a preset image matching the face image.

In some embodiments, if a preset image in the database matches the face image, identification corresponding to the preset image may be determined as identification of the target object. A visit record such as identification, visiting time, etc., of the target object may be recorded. If no preset image in the database matches the face image, another face image of the target object may be acquired for recognition and comparison. A number of comparisons may be limited to 5, for example. If comparison is performed 5 times for the target object, and identification of the target object matches no preset image, comparison may be stopped, the display device, the image acquiring device, etc., may be turned off, and notification information notifying of a recognition failure may be output.

Understandably, embodiments of a method herein may be combined with each other to form a combined embodiment as long as the combination does not go against a principle or a logic, which is not elaborated herein due to a space limitation.

In addition, embodiments herein further provide the abovementioned device for face recognition, electronic equipment, a computer-readable storage medium, and a program, all of which may be adapted to implementing any method for face recognition provided herein. Refer to disclosure for a method herein for a technical solution thereof and description therefor, which is not elaborated.

A person having ordinary skill in the art may understand that in a method herein, an order in which the operations are put does not mean a strict order of implementation, and constitutes no limitation to an implementation process. A specific order of implementing the operations should be determined based on functions thereof and a possibility intrinsic logic.

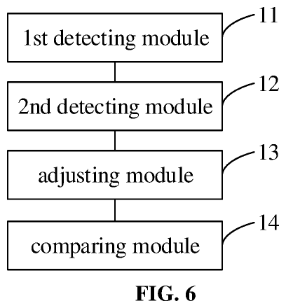

Embodiments herein further provide a device for face recognition, applied to a one-piece machine for face recognition. The one-piece machine for face recognition is provided with a display device. FIG. 6 is a block diagram of a device for face recognition according to an embodiment herein. As shown in FIG. 6, the device includes a first detecting module, a second detecting module, an adjusting module, and a comparing module.

The first detecting module 11 is configured for acquiring an ambient light parameter by detecting ambient light of a surveillance area.

The second detecting module 12 is configured for, in response to existence of a target object in the surveillance area, detecting a movement distance of the target object.

The adjusting module 13 is configured for, in response to the ambient light parameter meeting an ambient light condition and the movement distance of the target object being no less than a distance threshold, changing the ambient light parameter by adjusting screen brightness of the display device according to the ambient light parameter.

The comparing module 14 is configured for acquiring a face image of the target object after the ambient light parameter has been changed, acquiring a comparison result of comparing the face image to a preset image, and acquiring a face recognition result according to the comparison result.

In some embodiments, the ambient light parameter may include brightness of the ambient light. The ambient light condition may include that the brightness of the ambient light is no greater than a brightness threshold.

In some embodiments, the adjusting module 13 may be configured for: determining a display parameter of the display device according to the ambient light parameter; and adjusting the screen brightness of the display device according to the display parameter.

In some embodiments, the display parameter may include an area ratio of an adjustable area in the display device, and at least one of a grayscale, a brightness, and a chroma of the adjustable area.

In some embodiments, the adjusting module 13 may be configured for displaying a display interface in a predetermined mode on a display screen of the display device.

In some embodiments, the comparing module 14 may be configured for: acquiring a first image of the target object; performing image quality detection on the first image, and determining a first image meeting a quality condition as the face image of the target object.

In some embodiments, the comparing module 14 may be configured for: acquiring a liveness detection result of performing liveness detection on the face image; in response to the liveness detection result indicating liveness, acquiring a face feature of the target object by performing feature extraction processing on the target object in the face image; and acquiring the comparison result by comparing the face feature of the target object to a face feature in the preset image.

In some embodiments, the device may further include a controlling module configured for, in response to no face image of the target object being acquired in a preset time period, switching to a standby state.

In some embodiments, the device may further include a storing module configured for, in response to the face recognition result indicating that recognition succeeds, storing a visit record of the target object.

In some embodiments, the device may further include an executing module configured for: in response to the face recognition result indicating that recognition fails, acquiring another face image of the target object after the ambient light parameter has been changed, and acquiring a comparison result of comparing the another face image to the preset image; or outputting notification information notifying of a recognition failure.

A function or a module of a device for face recognition herein may be used for implementing a method described in a method embodiment herein. Refer to description of a method embodiment herein for specific implementation of the device, which is not repeated here for brevity.

Embodiments herein further disclose a computer-readable storage medium, having stored thereon computer program instructions which, when executed by a processor, implement a method for face recognition herein. The computer-readable storage medium may be a nonvolatile computer-readable storage medium.

Embodiments herein further disclose electronic equipment, which includes a processor and memory configured for storing instructions executable by the processor. The processor is configured for implementing a method for face recognition herein by running the instructions. The electronic device may be provided as a terminal, a server, or equipment in another form.

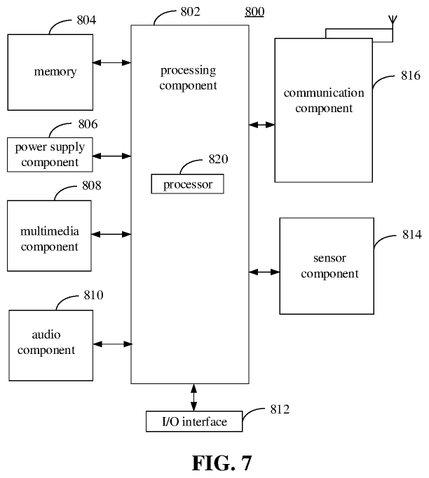

FIG. 7 is a block diagram of electronic equipment according to an embodiment herein. As shown in FIG. 7, the electronic equipment 800 may be any terminal of a mobile phone, a computer, digital broadcast terminal, message transceiver equipment, a gaming console, tablet equipment, medical equipment, fitness equipment, a Personal Digital Assistant, etc.

Referring to FIG. 7, the electronic equipment 800 may include one or more of a processing component 802, memory 804, a power supply component 806, a multimedia component 808, an audio component 810, an Input/Output (I/O) interface 812, a sensor component 814, a communication component 816, etc.

The processing component 802 may generally control an overall operation of the electronic equipment 800, such as operations associated with display, a telephone call, data communication, a camera operation, a recording operation, etc. The processing component 802 may include one or more processors 820 to execute instructions so as to complete all or some operations of the method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 may be adapted to storing various types of data to support the operation at the electronic equipment 800. Examples of such data may include instructions of any application or method adapted to operating on the electronic equipment 800, contact data, phone book data, messages, pictures, videos, etc. The memory 804 may be realized by any type of transitory or non-transitory storage equipment or combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, a magnetic disk, or a compact disk.

The power supply component 806 may supply electric power to various components of the electronic equipment 800. The power supply component 806 may include a power management system, one or more power sources, and other components related to generating, managing and distributing electricity for the electronic equipment 800.

The multimedia component 808 may include a screen providing an output interface between the electronic equipment 800 and a user. The screen may include a Liquid Crystal Display (LCD), a Touch Panel (TP), etc. If the screen includes a TP, the screen may be realized as a touch screen to receive an input signal from a user. The TP may include one or more touch sensors for sensing touch, slide and gestures on the TP. The touch sensors not only may sense the boundary of a touch or slide move, but also detect the duration and pressure related to the touch or slide move. The multimedia component 808 may include a front camera and/or a rear camera. When the electronic equipment 800 is in an operation mode such as a photographing mode or a video mode, the front camera and/or the rear camera may receive external multimedia data. Each of the front camera or the rear camera may be a fixed optical lens system or may have a focal length and be capable of optical zooming.

The audio component 810 may be adapted to outputting and/or inputting an audio signal. For example, the audio component 810 may include a microphone (MIC). When the electronic equipment 800 is in an operation mode such as a call mode, a recording mode, and a voice recognition mode, the MIC may be adapted to receiving an external audio signal. The received audio signal may be further stored in the memory 804 or may be sent via the communication component 816. The audio component 810 may further include a loudspeaker adapted to outputting the audio signal.

The I/O interface 812 may provide an interface between the processing component 802 and a peripheral interface module. Such a peripheral interface module may be a keypad, a click wheel, a button, and/or the like. Such a button may include but is not limited to: a homepage button, a volume button, a start button, and a lock button.

The sensor component 814 may include one or more sensors for assessing various states of the electronic equipment 800. For example, the sensor component 814 may detect an on/off state of the electronic equipment 800 and relative positioning of components such as the display and the keypad of the electronic equipment 800. The sensor component 814 may further detect a change in the position of the electronic equipment 800 or of a component of the electronic equipment 800, whether there is contact between the electronic equipment 800 and a user, the orientation or acceleration/deceleration of the electronic equipment 800, a change in the temperature of the electronic equipment 800. The sensor component 814 may include a proximity sensor adapted to detecting existence of a nearby object without physical contact. The sensor component 814 may further include an optical sensor such as a Complementary Metal-Oxide-Semiconductor (CMOS) or a Charge-Coupled Device (CCD) image sensor used in an imaging application. The sensor component 814 may further include an acceleration sensor, a gyroscope sensor, a magnetic sensor, a distance sensor, a pressure sensor, or a temperature sensor.

The communication component 816 may be adapted to facilitating wired or wireless communication between the electronic equipment 800 and other equipment. The electronic equipment 800 may access a wireless network based on a communication standard such as Wi-Fi, 2G, 3G, or combination thereof. The communication component 816 may broadcast related information or receive a broadcast signal from an external broadcast management system via a broadcast channel The communication component 816 may further include a Near Field Communication (NFC) module for short-range communication. For example, the NFC module may be based on technology such as Radio Frequency Identification (RFID), Infrared Data Association (IrDA), Ultra Wideband (UWB) technology, Bluetooth (BT), etc.

The electronic equipment 800 may be realized by one or more electronic components such as an Application Specific Integrated Circuit (ASIC), a Digital Signal Processor (DSP), a Digital Signal Processing Device (DSPD), a Programmable Logic Device (PLD), a Field-Programmable Gate Array (FPGA), a controller, a microcontroller, a microprocessor, etc., to implement the method.

According to an exemplary embodiment herein, a non-volatile computer-readable storage medium, such as the memory 804 including computer program instructions, may be provided. The computer program instructions may be executed by the processing component 802 of the electronic equipment 800 to implement a method herein.

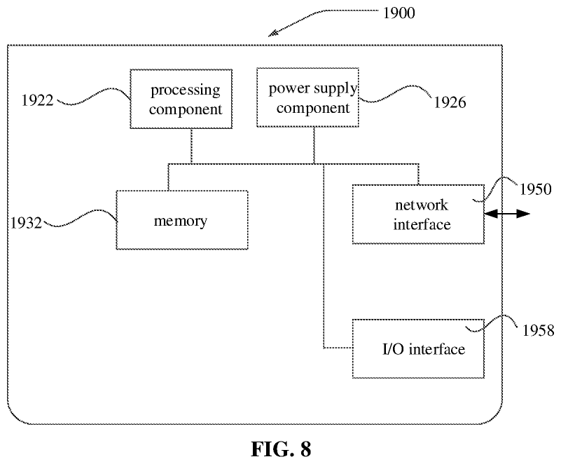

FIG. 8 is a block diagram of electronic equipment according to an exemplary embodiment. For example, the electronic equipment 1900 may be provided as a server. Referring to FIG. 8, the electronic equipment 1900 may include a processing component 1922. The processing component may include one or more processors. The device may include a memory resource represented by memory 1932. The memory may be adapted to storing an instruction executable by the processing component 1922, such as an APP. The APP stored in the memory 1932 may include one or more modules. Each of the modules may correspond to a group of instructions. In addition, the processing component 1922 may be adapted to executing instructions to perform a method for face recognition herein.

The electronic equipment 1900 may further include a power supply component 1926. The power supply component may be adapted to managing power of the electronic equipment 1900. The device may further include a wired or wireless network interface 1950 adapted to connecting the electronic equipment 1900 to a network. The device may further include an Input/Output (I/O) interface 1958. The electronic equipment 1900 may operate based on an operating system stored in the memory 1932, such as a Windows Server™, a Mac OS X™, a Unix™, a Linux™, a FreeBSD™, etc.

According to an exemplary embodiment herein, a non-transitory computer-readable storage medium including instructions, such as the memory 1932 including instructions, may be provided. The instructions may be executed by the processing component 1922 of the electronic equipment 1900 to implement a method for face recognition herein.

The disclosure may be a system, a method, and/or a computer program product. The computer program product may include a computer-readable storage medium, having borne thereon computer-readable program instructions allowing a processor to implement various aspects herein.

A computer-readable storage medium may be tangible equipment capable of keeping and storing an instruction used by instruction executing equipment. For example, a computer-readable storage medium may be, but is not limited to, electric storage equipment, magnetic storage equipment, optical storage equipment, electromagnetic storage equipment, semiconductor storage equipment, or any appropriate combination thereof. A non-exhaustive list of more specific examples of a computer-readable storage medium may include a portable computer disk, a hard disk, Random Access Memory (RAM), Read-Only Memory (ROM), Erasable Programmable Read-Only Memory (EPROM, or flash memory), Static Random Access Memory (SRAM), Compact Disc Read-Only Memory (CD-ROM), a Digital Versatile Disk (DVD), a memory stick, a floppy disk, mechanical coding equipment such as a protruding structure in a groove or a punch card having stored thereon an instruction, as well as any appropriate combination thereof. A computer-readable storage medium used here may not be construed as a transient signal per se, such as a radio wave, another freely propagated electromagnetic wave, an electromagnetic wave propagated through a wave guide or another transmission medium (such as an optical pulse propagated through an optical fiber cable), or an electric signal transmitted through a wire.

A computer-readable program instruction described here may be downloaded from a computer-readable storage medium to respective computing/processing equipment, or to an external computer or external storage equipment through a network such as the Internet, a Local Area Network (LAN), a Wide Area Network (WAN), and/or a wireless network. A network may include a copper transmission cable, optical fiber transmission, wireless transmission, a router, a firewall, a switch, a gateway computer, and/or an edge server. A network adapter card or a network interface in respective computing/processing equipment may receive the computer-readable program instruction from the network, and forward the computer-readable program instruction to computer-readable storage media in respective computing/processing equipment.

A computer program instruction for implementing an operation herein may be an assembly instruction, an Instruction Set Architecture (ISA) instruction, a machine instruction, a machine related instruction, a microcode, a firmware instruction, state setting data, or a source code or object code written in any combination of one or more programming languages. A programming language may include an object-oriented programming language such as Smalltalk, C++, etc., as well as a conventional procedural programming language such as C or a similar programming language. Computer-readable program instructions may be executed on a computer of a user entirely or in part, as a separate software package, partly on the computer of the user and partly on a remote computer, or entirely on a remote computer/server. When a remote computer is involved, the remote computer may be connected to the computer of a user through any type of network including an LAN or a WAN. Alternatively, the remote computer may be connected to an external computer (such as connected through the Internet using an Internet service provider). In some embodiments, an electronic circuit such as a programmable logic circuit, a Field-Programmable Gate Array (FPGA), or a Programmable Logic Array (PLA) may be customized using state information of a computer-readable program instruction. The electronic circuit may execute the computer-readable program instruction, thereby implementing an aspect herein.

Aspects herein have been described with reference to flowcharts and/or block diagrams of the method, device (system), and computer program product herein. It is be understood that each block in the flowcharts and/or the block diagrams and a combination of respective blocks in the flowcharts and/or the block diagrams may be implemented by computer-readable program instructions.

These computer-readable program instructions may be provided to a general-purpose computer, a dedicated computer, or a processor of another programmable data processing device, thereby producing a machine to allow the instruction to produce, when executed through a computer or the processor of another programmable data processing device, a device implementing a function/move specified in one or more blocks in the flowcharts and/or the block diagrams. The computer-readable program instructions may also be stored in a computer-readable storage medium. The instructions allow a computer, a programmable data processing device and/or other equipment to work in a specific mode. Accordingly, the computer-readable medium including the instructions includes a manufactured article including instructions for implementing each aspect of a function/move specified in one or more blocks in the flowcharts and/or the block diagrams.

Computer-readable program instructions may also be loaded to a computer, another programmable data processing device, or other equipment, such that a series of operations are executed in the computer, the other programmable data processing device, or the other equipment to produce a computer implemented process, thereby allowing the instructions executed on the computer, the other programmable data processing device, or the other equipment to implement a function/move specified in one or more blocks in the flowcharts and/or the block diagrams.

The flowcharts and block diagrams in the drawings show possible implementation of architectures, functions, and operations of the system, method, and computer program product according to multiple embodiments herein. In this regard, each block in the flowcharts or the block diagrams may represent part of a module, a program segment, or an instruction. The part of the module, the program segment, or the instruction includes one or more executable instructions for implementing a specified logical function. In some alternative implementations, functions noted in the blocks may also occur in an order different from that noted in the drawings. For example, two consecutive blocks may actually be implemented basically in parallel. They sometimes may also be implemented in a reverse order, depending on the functions involved. Also note that each block in the block diagrams and/or the flowcharts, as well as a combination of the blocks in the block diagrams and/or the flowcharts, may be implemented by a hardware-based application-specific system for implementing a specified function or move, or by a combination of an application-specific hardware and a computer instruction.

Description of embodiments herein is exemplary, not exhaustive, and not limited to the embodiments disclosed herein. Various modification and variations can be made without departing from the principle of embodiments herein. The modification and variations will be apparent to a person having ordinary skill in the art. Choice of a term used herein is intended to best explain the principle and/or application of the embodiments, or improvement to technology in the market, or allow a person having ordinary skill in the art to understand the embodiments disclosed herein.

What is claimed is:

1. A method for face recognition, applied to a one-piece machine for face recognition, the one-piece machine for face recognition being provided with a display device, the method comprising:
acquiring an ambient light parameter by detecting ambient light of a surveillance area;
in response to existence of a target object in the surveillance area, detecting a movement distance of the target object;
in response to the ambient light parameter meeting an ambient light condition and the movement distance of the target object being no less than a distance threshold, changing the ambient light parameter by adjusting screen brightness of the display device according to the ambient light parameter; and
acquiring a face image of the target object after the ambient light parameter has been changed, acquiring a comparison result of comparing the face image to a preset image, and acquiring a face recognition result according to the comparison result.

2. The method of claim 1, wherein the ambient light parameter comprises brightness of the ambient light, wherein the ambient light condition comprises that the brightness of the ambient light is no greater than a brightness threshold.

3. The method of claim 1, wherein adjusting the screen brightness of the display device according to the ambient light parameter comprises:
determining a display parameter of the display device according to the ambient light parameter; and
adjusting the screen brightness of the display device according to the display parameter.

4. The method of claim 3, wherein the display parameter comprises an area ratio of an adjustable area in the display device, and at least one of a grayscale, a brightness, and a chroma of the adjustable area.

5. The method of claim 1, wherein adjusting the screen brightness of the display device according to the ambient light parameter comprises:
displaying a display interface in a predetermined mode on a display screen of the display device.

6. The method of claim 1, wherein acquiring the face image of the target object after the ambient light parameter has been changed comprises:
acquiring a first image of the target object; and
performing image quality detection on the first image, and determining a first image meeting a quality condition as the face image of the target object.

7. The method of claim 1, wherein acquiring the comparison result of comparing the face image to the preset image comprises:
acquiring a liveness detection result of performing liveness detection on the face image;
in response to the liveness detection result indicating liveness, acquiring a face feature of the target object by performing feature extraction processing on the target object in the face image; and
acquiring the comparison result by comparing the face feature of the target object to a face feature in the preset image.

8. The method of claim 1, further comprising:
in response to no face image of the target object being acquired in a preset time period, switching to a standby state.

9. The method of claim 1, further comprising:
in response to the face recognition result indicating that recognition succeeds, storing a visit record of the target object.

10. The method of claim 1, further comprising: in response to the face recognition result indicating that recognition fails,
acquiring another face image of the target object after the ambient light parameter has been changed, and acquiring a comparison result of comparing the another face image to the preset image; or
outputting notification information notifying of a recognition failure.

11. Electronic equipment, comprising a processor and memory,
wherein the memory is configured for storing instructions executable by the processor.
wherein the processor is configured for:
acquiring an ambient light parameter by detecting ambient light of a surveillance area;
in response to existence of a target object in the surveillance area, detecting a movement distance of the target object;
in response to the ambient light parameter meeting an ambient light condition and the movement distance of the target object being no less than a distance threshold, changing the ambient light parameter by adjusting screen brightness of a display device according to the ambient light parameter; and
acquiring a face image of the target object after the ambient light parameter has been changed, acquiring a comparison result of comparing the face image to a preset image, and acquiring a face recognition result according to the comparison result.

12. The electronic equipment of claim 11, wherein the ambient light parameter comprises brightness of the ambient light, wherein the ambient light condition comprises that the brightness of the ambient light is no greater than a brightness threshold.

13. The electronic equipment of claim 11, wherein the processor is configured for adjusting the screen brightness of the display device according to the ambient light parameter by:
determining a display parameter of the display device according to the ambient light parameter; and
adjusting the screen brightness of the display device according to the display parameter.

14. The electronic equipment of claim 13, wherein the display parameter comprises an area ratio of an adjustable area in the display device, and at least one of a grayscale, a brightness, and a chroma of the adjustable area.

15. The electronic equipment of claim 11, wherein the processor is configured for adjusting the screen brightness of the display device according to the ambient light parameter by:
displaying a display interface in a predetermined mode on a display screen of the display device.

16. The electronic equipment of claim 11, wherein the processor is configured for acquiring the face image of the target object after the ambient light parameter has been changed by:
acquiring a first image of the target object; and
performing image quality detection on the first image, and determining a first image meeting a quality condition as the face image of the target object.

17. The electronic equipment of claim 11, wherein the processor is configured for acquiring the comparison result of comparing the face image to the preset image by:
acquiring a liveness detection result of performing liveness detection on the face image;
in response to the liveness detection result indicating liveness, acquiring a face feature of the target object by performing feature extraction processing on the target object in the face image; and
acquiring the comparison result by comparing the face feature of the target object to a face feature in the preset image.

18. The electronic equipment of claim 11, wherein the processor is further configured for:
in response to no face image of the target object being acquired in a preset time period, switching to a standby state.

19. The electronic equipment of claim 11, wherein the processor is further configured for:
in response to the face recognition result indicating that recognition succeeds, storing a visit record of the target object.

20. A non-transitory computer-readable storage medium, having stored thereon computer program instructions which, when executed by a processor, implement:
acquiring an ambient light parameter by detecting ambient light of a surveillance area;
in response to existence of a target object in the surveillance area, detecting a movement distance of the target object;
in response to the ambient light parameter meeting an ambient light condition and the movement distance of the target object being no less than a distance threshold, changing the ambient light parameter by adjusting screen brightness of a display device according to the ambient light parameter; and
acquiring a face image of the target object after the ambient light parameter has been changed, acquiring a comparison result of comparing the face image to a preset image, and acquiring a face recognition result according to the comparison result.
